(19) United States
(12) Patent Application Publication
(10) Pub. No.: US 2010/0317525 A1
(43) Pub. Date: Dec. 16, 2010

(54) HERBICIDAL MIXTURE

(75) Inventor: Edison Hidalgo, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/740,382

(22) PCT Filed: Nov. 11, 2008
(86) PCT No.: PCT/US08/83071

§ 371 Date: Jun. 25, 2010

Related U.S. Application Data
(60) Provisional application No. 60/987,242, filed on Nov. 12, 2007.

(51) Int. Cl. A01N 43/66; A01P 13/00

(52) U.S. Cl. 504/231

(57) ABSTRACT

A mixture of diuron, hexazinone and tembotrione is disclosed as useful for controlling undesired vegetation. Also disclosed is a herbicidal composition comprising diuron, hexazinone and tembotrione, and at least one additional component selected from the group consisting of surfactants, solid diluents and liquid diluents. Further disclosed is a method of controlling undesired vegetation comprising applying to the locus of the vegetation a herbicidally effective amount of the mixture.

### FIELD OF THE INVENTION

This invention relates to mixtures of herbicidal compounds and their compositions, and methods using the mixtures and compositions for controlling undesired vegetation.

### BACKGROUND OF THE INVENTION

The control of undesired vegetation is extremely important in achieving high crop efficiency. Achievement of selective control of the growth of weeds especially in such useful crops as rice, soybean, sugar beet, corn (maize), potato, wheat, barley, tomato and plantation crops such as sugarcane, among others, is very desirable. Unchecked weed growth in such useful crops can cause significant reduction in productivity and thereby result in increased costs to the consumer. The control of undesired vegetation in noncrop areas is also important. Many products are commercially available for these purposes, but the need continues for new products that are more effective, less costly, less toxic, environmentally safer or have different modes of action.

Combinations of herbicides are typically used to broaden the spectrum of plant control or enhance the level of control of any given species through additive effect. Furthermore, certain rare combinations unexpectedly give a greater-than-additive or synergistic effect on weeds or a less-then-additive or safening effect on crops.

Diuron (N′(3,4-dichlorophenyl)-N,N-dimethylurea), disclosed in U.S. Pat. No. 2,655,445, and hexazinone (3-cyclohexyl-6-(dimethylamino)-1-methyl-1,3,5-triazine-2,4-(1H,3H)-dione), disclosed in U.S. Pat. No. 3,902,887, are photosystem II electron-transport-inhibiting herbicides which are often applied together, for example as VELPAR-K and the Brazilian product ADVANCE, both sold by DuPont, in certain crops such as alfalfa, pineapples, sugarcane and conifer plantations. The effects of these two herbicides are complementary. Although these two herbicides together effectively control most problematic weeds in the above-mentioned crops, their combined spectrum of weed control is nevertheless not entirely complete.

Tembotrione (2-[2-chloro-4-(methylsulfonyl)-3-[(2,2,2-trifluoroethoxy)methyl]-benzoyl]-1,3-cyclohexanedione), disclosed in U.S. Pat. No. 6,376,429, is a relatively new herbicide developed for selective control of broad-leaved weeds along with some grass weeds in maize. Tembotrione is effective for both preemergence and postemergence application, and unlike diuron, lower application rates are typically needed for satisfactory control from postemergence compared to preemergence applications. Although tembotrione is useful for postemergent weed control, it is weak on some weeds, particularly grasses. For control of these weeds, new solutions are desirable.

### SUMMARY OF THE INVENTION

This invention provides a mixture comprising diuron (the compound of Formula I),

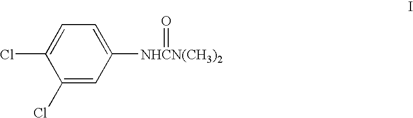

hexazinone (the compound of Formula II),

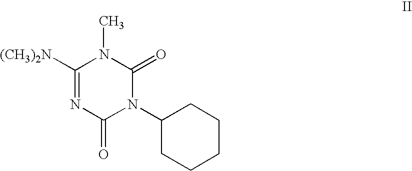

and at least one compound selected from tembotrione (the compound Formula III)

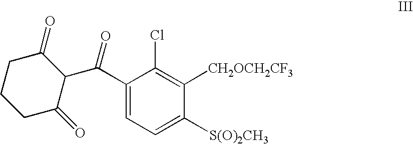

and salts thereof.

This invention also provides a herbicidal composition comprising diuron, hexazinone, at least one compound selected from tembotrione and salts thereof, and at least one additional component selected from the group consisting of surfactants, solid diluents and liquid diluents. This invention also provides a method of controlling undesired vegetation comprising applying to the locus of the undesired vegetation a herbicidally effective amount of the aforesaid mixture (e.g., as a herbicidal composition thereof). This invention also relates to the aforesaid mixture and composition further comprising at least one additional biologically active compound or agent (i.e. in biologically effective amount), and method of controlling undesired vegetation comprising applying to the locus of the undesired vegetation a herbicidally effective amount of said mixture or composition.

### DETAILS OF THE INVENTION

As used herein, the terms “comprises,” “comprising,” “includes,” “including,” “has,” “having” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

The term “sugarcane” refers to species of the genus Saccharum having a sucrose content useful for sugar production, particularly S. officinarum L., S. barberi Jesw., S. robustum Brandes, Jeswiet ex Grassl, S. sinense Roxb., S. spontaneum L. and S. edule Hassk., and hybrids and cultivars thereof.

As used in the present disclosure and claims, “locus of vegetation” refers to the vegetation and its environment (i.e. the area in which the vegetation grows or may grow). Related expressions have analogous meanings. For example, “locus of undesired vegetation” refers to the undesired vegetation and its environment (i.e. the area in which the undesired vegetation grows or may grow.)

The term “control” as used in the present disclosure and claims, means to prevent the appearance of undesired vegetation or to reduce its growth or vigor.

Embodiments of the present invention as described in the Summary of the Invention include (where tembotrione as used in the following Embodiments means at least one compound selected from tembotrione and salts thereof, unless specified otherwise):

### Embodiment 1

A mixture or composition described in the Summary of the Invention comprising diuron, hexazinone and tembotrione and at least one additional biologically active compound or agent.

### Embodiment 2

A mixture or composition described in the Summary of the Invention or Embodiment 1 not further comprising an additional herbicidally active compound or agent (i.e. only diuron, hexazinone and tembotrione as herbicidally active compounds or agents).

### Embodiment 3

A composition described in the Summary of the Invention or Embodiment 1 or 2 which is a homogeneous mixture comprising two groups of substantially cylindrical granules, the groups having different herbicide contents, the first group of granules comprising diuron and hexazinone and at least one solid diluent, and the second group of granules comprising at least one compound selected from tembotrione and salts thereof and at least one solid diluent, the granules within each group having substantially uniform diameters and longitudinal lengths of from 1 to 8 times the diameter with the average length of the granules being from 1.5 to 4 times the diameter, and the average diameter of the second group differing from the first group by no more than 30%.

### Embodiment 4

A composition described in the Summary of the Invention or Embodiment 1 or 2 which is a homogeneous mixture comprising three groups of substantially cylindrical granules, the groups having different herbicide contents, the first group of granules comprising diuron and at least one solid diluent, the second group of granules comprising hexazinone at least one solid diluent and the third group of granules comprising at least one compound selected from tembotrione and salts thereof and at least one solid diluent, the granules within each group having substantially uniform diameters and longitudinal lengths of from 1 to 8 times the diameter with the average length of the granules being from 1.5 to 4 times the diameter, and the average diameter of the second group differing from the first group by no more than 30%.

### Embodiment 5

A method according to the Summary of the Invention wherein a herbicidally effective amount of a mixture or composition comprising diuron, hexazinone and tembotrione or a mixture or composition of any one of Embodiments 1 through 4 is applied to the locus of the undesired vegetation.

### Embodiment 6

The method of Embodiment 5 wherein the locus of the undesired vegetation is in an alfalfa, conifer (i.e. conifer plantation), pineapple or sugarcane crop.

### Embodiment 7

The method of Embodiment 6 wherein the locus of the undesired vegetation is in an alfalfa crop.

### Embodiment 8

The method of Embodiment 6 wherein the locus of the undesired vegetation is in a conifer crop (i.e. conifer plantation).

### Embodiment 9

The method of Embodiment 6 wherein the locus of the undesired vegetation is in a pineapple crop.

### Embodiment 10

The method of Embodiment 6 wherein the locus of the undesired vegetation is in a sugarcane crop.

### Embodiment 11

The method of Embodiment 5 wherein the locus of the undesired vegetation is other than in a crop.

### Embodiment 12

A method described in the Summary of the Invention or any one of Embodiments 5 through 11 wherein the undesired vegetation is a monocot plant species.

### Embodiment 13

The method of Embodiment 12 wherein the undesired vegetation is a plant species in the family Poaceae.

### Embodiment 14

The method of Embodiment 13 wherein the undesired vegetation is a plant species in the genus Digitaria.

### Embodiment 15

The method of Embodiment 14 wherein the undesired vegetation is Digitaria nuda or Digitaria horizontalis.

### Embodiment 16

The method of Embodiment 15 wherein the undesired vegetation is Digitaria nuda.

### Embodiment 17

The method of Embodiment 12 wherein the undesired vegetation is a plant species in the family Cyperaceae.

### Embodiment 18

The method of Embodiment 17 wherein the undesired vegetation is a plant species in the genus Cyperus.

### Embodiment 19

The method of Embodiment 18 wherein the undesired vegetation is Cyperus esculentus.

### Embodiment 20

A method described in the Summary of the Invention or any one of Embodiments 5 through 19 wherein the herbicidal mixture or composition comprising diuron, hexazinone and tembotrione is applied after emergence of the undesired vegetation.

Embodiments of this invention can be combined in any manner.

Of note is the alternative wording equivalent in meaning to Embodiment 2: “A mixture or composition described in the Summary of the Invention or Embodiment 1 not further comprising herbicidally active compounds or agents.”

Of note is a method, mixture or composition as described in the Summary of the Invention or in any one of Embodiments 1-20 wherein the mixture or composition comprising diuron, hexazinone and tembotrione does not further comprise any other herbicidally active compounds or agents. Also of note is a method, mixture or composition as described in the Summary of the Invention or in any one of Embodiments 1-20 wherein the mixture or composition comprising diuron, hexazinone and tembotrione does not further comprise any other herbicidally active compounds or agents, or herbicide safeners. Also of note is a method, mixture or composition as described in the Summary of the Invention or in any one of Embodiments 1-20 wherein the mixture or composition comprising diuron, hexazinone and tembotrione does not further comprise any other biologically active compounds or agents.

Of note is a method, mixture or composition as described in the Summary of the Invention or in any one of Embodiments 1-20 wherein the tembotrione is in the free-acid form (i.e. not as a salt).

In the subsequent disclosure, recitation of “tembotrione” refers to tembotrione in one or more of its forms (i.e. free acid, salts) unless precluded by the context or specified otherwise.

Diuron (Formula I) is commercially available in herbicidal compositions sold by a variety of companies including DuPont (e.g., KARMEX® Herbicide). Although diuron is most conveniently obtained as a commercial product, it can be prepared by methods described in U.S. Pat. No. 2,655,445.

Hexazinone (Formula II) is commercially available in herbicidal compositions sold by a variety of companies including DuPont (e.g., VELPAR® Herbicide). Although hexazinone is most conveniently obtained as a commercial product, it can be prepared by methods described in U.S. Pat. No. 3,902,887.

Furthermore, mixtures of diuron and hexazinone are commercially available in certain ratios in herbicidal composition products such as VELPAR®-K Herbicide and the Brazilian product ADVANCE® Herbicide, both sold by DuPont.

Tembotrione (Formula III) is commercially available in herbicidal compositions sold by Bayer (e.g., in combination with isoxadifen-ethyl in LAUDIS® Herbicide). Also, tembotrione can be prepared as described in U.S. Pat. No. 6,376,429.

As tembotrione is acidic, the mixture of the present invention can include tembotrione as one or more salts. The salts of tembotrione include those formed with organic bases (e.g., pyridine, ammonia, or triethylamine) or inorganic bases (e.g., hydrides, hydroxides, or carbonates of sodium, potassium, lithium, calcium, magnesium or barium). Besides containing metal cations such as alkali metal (e.g., sodium, potassium, lithium) and alkaline earth metal (e.g., calcium, magnesium, barium), salts of tembotrione can also include sulfonium, sulfoxonium or quaternary ammonium cations. Salts of tembotrione can be prepared in a number of ways known in the art for preparing salts of acidic organic compounds. For example, metal salts can be made by contacting tembotrione in its acid form (Formula III) with a solution of an alkali or alkaline earth metal salt having a sufficiently basic anion (e.g., hydroxide, alkoxide, carbonate or hydride). Quaternary ammonium salts can be made by similar techniques.

Salts of tembotrione can also be prepared by exchange of one cation for another. Cationic exchange can be effected by direct contact on an aqueous solution of a salt of tembotrione (e.g., alkali or quaternary ammonium salt) with a solution containing the cation to be exchanged. The method is most effective when the desired salt containing the exchanged cation is insoluble in water and can be separated by filtration.

Exchange may also be effected by passing an aqueous solution of a salt of a compound of tembotrione (e.g., an alkali metal or quaternary ammonium salt) through a column packed with a cation-exchange resin containing the cation to be exchanged for that of the original salt, and the desired product is eluted from the column. This method is particularly useful when the desired salt is water soluble (e.g., potassium, sodium or calcium salt).

### Formulation/Utility

The mixture of this invention can be formulated in a number of ways:
(a) diuron (Formula I), hexazinone (Formula II) and tembotrione (Formula III, including salts thereof) can be formulated into separate herbicidal compositions and applied separately or applied simultaneously (e.g., as a tank mix) in an appropriate weight ratio; or
(b) diuron (Formula I), hexazinone (Formula II) and tembotrione (Formula III, including salts thereof) can be formulated together in the desired weight ratio in a single herbicidal composition.
   Other possibilities include formulating two of the active ingredients (e.g., diuron and hexazinone) together and the other (e.g., tembotrione) separately, and then applying the two formulations separately or simultaneously. Furthermore, additional biologically active compounds or agents included in the mixture can similarly be formulated and applied separately or together.

Diuron, hexazinone, tembotrione and their mixtures, including their mixtures with other biologically active compounds or agents will generally be used in a formulation (i.e. herbicidal composition) with an agriculturally suitable carrier comprising at least one of a liquid diluent, a solid diluent or a surfactant. The formulation or composition ingredients are selected to be consistent with the physical properties of the active ingredients, mode of application and environmental factors such as soil type, moisture and temperature. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films (including seed coatings), and the like which can be water-dispersible (“wettable”) or water-soluble. Active ingredient can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended (i.e. dispersed or dissolved) in suitable media and used at spray volumes from about one to several hundred liters per hectare. High-strength compositions are primarily used as intermediates for further formulation.

The formulations will typically contain effective amounts of active ingredients, diluent and surfactant within the following approximate ranges which add up to 100 percent by weight.

| | Weight Percent | | |
|---|---|---|---|
| | Active | | |
| | Ingredient | Diluent | Surfactant |
| Water-Dispersible and Water- | 0.001-90 | 0-99.999 | 0-15 |
| soluble Granules, Tablets and | | | |
| Powders. | | | |
| Suspensions, Emulsions, | 1-50 | 40-99 | 0-50 |
| Solutions (including | | | |
| Emulsifiable Concentrates) | | | |
| Dusts | 1-25 | 70-99 | 0-5 |
| Granules and Pellets | 0.001-99 | 5-99.999 | 0-15 |
| High Strength Compositions | 90-99 | 0-10 | 0-2 |

Typical solid diluents are described in Watkins et al., Handbook of Insecticide Dust Diluents and Carriers, 2nd Ed., Dorland Books, Caldwell, N.J. Typical liquid diluents are described in Marsden, Solvents Guide, 2nd Ed., Interscience, New York, 1950. McCutcheon's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, glycerol esters, poly-oxyethylene/polyoxypropylene block copolymers, and alkylpolyglycosides where the number of glucose units, referred to as degree of polymerization (D.P.), can range from 1 to 3 and the alkyl units can range from C₆ to C₁₄ (see Pure and Applied Chemistry 72, 1255-1264). Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, propylene carbonate, dibasic esters, paraffins, alkylbenzenes, alkylnaphthalenes, glycerine, triacetine, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, acetates such as hexyl acetate, heptyl acetate and octyl acetate, and alcohols such as methanol, cyclohexanol, decanol, benzyl and tetrahydrofurfuryl alcohol.

Useful formulations of this invention may also contain materials well known to those skilled in the art as formulation aids such as antifoams, film formers and dyes. Antifoams can include water dispersible liquids comprising polyorganosiloxanes like Rhodorsil® 416. The film formers can include polyvinyl acetates, polyvinyl acetate copolymers, polyvinylpyrrolidone-vinyl acetate copolymer, polyvinyl alcohols, polyvinyl alcohol copolymers and waxes. Dyes can include water dispersible liquid colorant compositions like Pro-lzed® Colorant Red. One skilled in the art will appreciate that this is a non-exhaustive list of formulation aids. Suitable examples of formulation aids include those listed herein and those listed in McCutcheon's 2001, Volume 2: Functional Materials published by MC Publishing Company and PCT Publication WO 03/024222.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

Homogeneous mixtures (i.e. blends) of substantially cylindrical granules (also described as pellets), which can be formed by extrusion or pelletization, as taught in U.S. Pat. No. 6,022,552 provide a particularly convenient means of preparing the herbicidal composition of the present invention, as this technology allows easily varying the ratios between diuron, hexazinone and tembotrione after extrusion and sizing or pelletization. U.S. Pat. No. 6,270,025 teaches a commercially useful method for sizing extruded granules in length ranges suitable for these homogeneous mixtures. The homogeneous mixture described in U.S. Pat. No. 6,022,552 comprises two or more groups of solid pesticide (e.g., herbicide) granules, wherein one group has one pesticide or pesticide content and one or more other groups have a different pesticide, a different pesticide content or an inert content, the granules within each group being formed by extrusion or pelletization and being substantially cylindrical in shape, having substantially uniform diameters and longitudinal lengths 1 to 8 times the diameter with the average length of the granules being 1.5 to 4 times the diameter, and the average diameter of each group differing from another group by no more than 30%. What is meant by substantially cylindrical is rod like or tubular wherein the cross-sectional shape may be circular, octagonal, rectangular, or any other conceivable shape and wherein the longitudinal surface is spiral, curved, or straight. The difference in average diameter is calculated by subtracting the average diameter of the granules in the group having the smaller diameter from the average diameter of the granules in the group having the larger diameter, then dividing the calculated difference by the average diameter of the granules in the group having the smaller diameter, and finally multiplying the calculated quotient by 100%. The inert content relates to ingredients other than the pesticidal active ingredients. In homogeneous mixtures of substantially cylindrical granules, granules comprising an active ingredient typically also comprise at least one solid diluent, and most typically also comprise at least one surfactant.

For the compositions of the present invention, in the homogeneous mixture one group of granules can comprise diuron, a second group of granules can comprise hexazinone and a third group of granules can comprise tembotrione. Alternatively, two or more biologically active compounds or agents can be contained in one of the groups of granules. For example, the first group of granules can comprise diuron and hexazinone, and the second group of granules can comprise tembotrione. Alternatively, the first group of granules can comprise diuron and tembotrione, and the second group of granules can comprise hexazinone. As another example, the first group of granules can comprise hexazinone and tembotrione, and the second group of granules can comprise diuron.

For further information regarding the art of formulation, see T. S. Woods, “The Formulator's Toolbox-Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, UK, 2000.

In the following Examples, all percentages are by weight and all formulations are prepared in conventional ways.

### EXAMPLE A

High Strength Concentrate

| | |
|---|---|
| diuron | 78.5% |
| hexazinone | 19.6% |
| tembotrione | 0.4% |
| silica aerogel | 0.5% |
| synthetic amorphous fine silica | 1.0%. |

### EXAMPLE B

High Strength Concentrate

| | |
|---|---|
| diuron | 43.8% |
| hexazinone | 10.9% |
| tembotrione | 43.8% |
| silica aerogel | 0.5% |
| synthetic amorphous fine silica | 1.0%. |

### EXAMPLE C

Wettable Powder

| | |
|---|---|
| diuron | 56.4% |
| hexazinone | 5.6% |
| tembotrione | 3.0% |
| dodecylphenol polyethylene glycol ether | 2.0% |
| sodium ligninsulfonate | 4.0% |
| sodium silicoaluminate | 6.0% |
| montmorillonite (calcined) | 23.0%. |

### EXAMPLE D

Granule

| | |
|---|---|
| diuron | 7.2% |
| hexazinone | 2.4% |
| tembotrione | 0.4% |
| attapulgite granules (low volatile matter, | 90.0%. |
| 0.71/0.30 mm; U.S.S. No. 25-50 sieves) | |

### EXAMPLE E

Aqueous Suspension

| | |
|---|---|
| diuron | 18.6% |
| hexazinone | 5.2% |
| tembotrione | 1.2% |
| hydrated attapulgite | 3.0% |
| crude calcium ligninsulfonate | 10.0% |
| sodium dihydrogen phosphate | 0.5% |
| water | 61.5%. |

### EXAMPLE F

Extruded Granule (Pellet)

| | |
|---|---|
| diuron | 20.8% |
| hexazinone | 2.6% |
| tembotrione | 1.6% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0%. |

### EXAMPLE G

Microemulsion

| | |
|---|---|
| diuron | 0.7% |
| hexazinone | 0.2% |
| tembotrione | 0.1% |
| triacetine | 30.0% |
| C₈-C₁₀ alkylpolyglycoside | 30.0% |
| glyceryl monooleate | 19.0% |
| water | 20.0%. |

### EXAMPLE H

Extruded Granule (Pellet)

| | |
|---|---|
| diuron | 19.6% |
| hexazinone | 5.2% |
| tembotrione, sodium salt | 1.2% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0%. |

### EXAMPLE I

Samples of the Diuron Extruded Granule, Tembotrione Extruded Granule, and Hexazinone Extruded Granule compositions containing the ingredients described below are separately prepared by extrusion of milled premixes moistened with water through a circular die to give after drying extrudates with diameters of 1.0 mm±0.1 mm. The extrudates are sized by tumbling in a rotary sifter to provide granules having lengths of at least 1.2 mm and not greater than 7.2 mm and a mean length of 2.5 mm.

Diuron Extruded Granule

| | |
|---|---|
| diuron | 30.0% |
| anhydrous sodium sulfate | 5.0% |
| crude calcium ligninsulfonate | 5.0% |
| sodium alkylnaphthalenesulfonate | 1.0% |
| calcium/magnesium bentonite | 59.0%. |

Tembotrione Extruded Granule

| | |
|---|---|
| tembotrione | 5.0% |
| anhydrous sodium sulfate | 30.0% |
| crude calcium ligninsulfonate | 5.0% |
| sodium alkylnaphthalenesulfonate | 1.0% |
| calcium/magnesium bentonite | 59.0%. |

Hexazinone Extruded Granule

| | |
|---|---|
| hexazinone | 15.0% |
| anhydrous sodium sulfate | 20.0% |
| crude calcium ligninsulfonate | 5.0% |
| sodium alkylnaphthalenesulfonate | 1.0% |
| calcium/magnesium bentonite | 59.0%. |

Then 250 g of the Diuron Extruded Granule composition, 80 g of the Tembotrione Extruded Granule composition and 140 g of the Hexazinone Extruded Granule composition are combined and thoroughly mixed by being placed in a bottle which is inverted until visually homogeneous and thereafter shaken on a mechanical shaker for 15 minutes to provide a homogeneous mixture with a composition of 16.0% diuron, 0.8% tembotrione and 4.5% hexazinone.

Mixtures and compositions comprising diuron, hexazinone and tembotrione can be used without additional biologically active compounds or agents or can be combined with one or more additional biologically active compounds or agents such as other herbicides, herbicide safeners, insecticides, insecticide synergists, fungicides, nematocides, bactericides, acaricides, growth regulators such as rooting stimulants, chemosterilants, semiochemicals, repellents, attractants, pheromones, feeding stimulants, other biologically active compounds including plant nutrients (i.e. fertilizers) or bacteria, virus or fungi pathogenic to plant, arthropod, nematode, bacterial or fungal pests to form a multi-component pesticide giving an even broader spectrum of agricultural utility. Combination of mixtures of diuron, hexazinone and tembotrione with other biologically active compounds or agents typically preserves the synergism between diuron, hexazinone and tembotrione for controlling weeds. Combination of mixtures of diuron, hexazinone and tembotrione with other herbicides can broaden the spectrum of activity against additional weed species, and suppress the proliferation of any resistant biotypes, and may enhance the synergistic (i.e. greater-than-additive) effect on weeds and/or provide a safening (i.e. less-than-additive) effect on crops or other desirable plants. Combination of one or more of the following herbicides in the mixture and composition of this invention may be particularly useful for weed control: acetochlor, acifluorfen and its sodium salt, aclonifen, acrolein (2-propenal), alachlor, alloxydim, ametryn, amicarbazone, amidosulfuron, aminocyclopyrachlor and its methyl and ethyl esters and its sodium and potassium salts, aminopyralid, amitrole, ammonium sulfamate, anilofos, asulam, atrazine, azimsulfuron, beflubutamid, benazolin, benazolin-ethyl, bencarbazone, benfluralin, benfuresate, bensulfuron-methyl, bensulide, bentazone, benzobicyclon, benzofenap, bifenox, bilanafos, bispyribac and its sodium salt, bromacil, bromobutide, bromofenoxim, bromoxynil, bromoxynil octanoate, butachlor, butafenacil, butamifos, butralin, butroxydim, butylate, cafenstrole, carbetamide, carfentrazone-ethyl, catechin, chlomethoxyfen, chloramben, chlorbromuron, chlorflurenol-methyl, chloridazon, chlorimuron-ethyl, chlorotoluron, chlorpropham, chlorsulfuron, chlorthal-dimethyl, chlorthiamid, cinidon-ethyl, cinmethylin, cinosulfuron, clethodim, clodinafop-propargyl, clomazone, clomeprop, clopyralid, clopyralid-olamine, cloransulam-methyl, CUH-35 (2-methoxyethyl 2-[[[4-chloro-2-fluoro-5-[(1-methyl-2-propynyl)oxy]-phenyl](3-fluorobenzoyl)amino] carbonyl]-1-cyclohexene-1-carboxylate), cumyluron, cyanazine, cycloate, cyclosulfamuron, cycloxydim, cyhalofop-butyl, 2,4-D and its butotyl, butyl, isoctyl and isopropyl esters and its dimethylammonium, diolamine and trolamine salts, daimuron, dalapon, dalapon-sodium, dazomet, 2,4-DB and its dimethylammonium, potassium and sodium salts, desmedipham, desmetryn, dicamba and its diglycolammonium, dimethylammonium, potassium and sodium salts, dichlobenil, dichlorprop, diclofop-methyl, diclosulam, difenzoquat metilsulfate, diflufenican, diflufenzopyr, dimefuron, dimepiperate, dimethachlor, dimethametryn, dimethenamid, dimethenamid-P, dimethipin, dimethylarsinic acid and its sodium salt, dinitramine, dinoterb, diphenamid, diquat dibromide, dithiopyr, DNOC, endothal, EPTC, esprocarb, ethalfluralin, ethametsulfuron-methyl, ethofumesate, ethoxyfen, ethoxysulfuron, etobenzanid, fenoxaprop-ethyl, fenoxaprop-P-ethyl, fentrazamide, fenuron, fenuron-TCA, flamprop-methyl, flamprop-M-isopropyl, flamprop-M-methyl, flazasulfuron, florasulam, fluazifop-butyl, fluazifop-P-butyl, fluazolate, flucarbazone, flucetosulfuron, fluchloralin, flufenacet, flufenpyr, flufenpyr-ethyl, flumetsulam, flumiclorac-pentyl, flumioxazin, fluometuron, fluoroglycofen-ethyl, flupoxam, flupyrsulfuron-methyl and its sodium salt, flurenol, flurenol-butyl, fluridone, flurochloridone, fluroxypyr, flurtamone, fluthiacet-methyl, fomesafen, foramsulfuron, fosamine-ammonium, glufosinate, glufosinate-ammonium, glyphosate and its salts such as ammonium, isopropylammonium, potassium, sodium (including sesquisodium) and trimesium (alternatively named sulfosate), halosulfuron-methyl, haloxyfop-etotyl, haloxyfop-methyl, hexazinone, HOK-201 (N-(2,4-difluorophenyl)-1,5-dihydro-N-(1-methylethyl)-5-oxo-1-[(tetrahydro-2H-pyran-2-yl)methyl]-4H-1,2,4-triazole-4-carboxamide, imazamethabenz-methyl, imazamox, imazapic, imazapyr, imazaquin, imazaquin-ammonium, imazethapyr, imazethapyr-ammonium, imazosulfuron, indanofan, iodosulfuron-methyl, ioxynil, ioxynil octanoate, ioxynil-sodium, isoproturon, isouron, isoxaben, isoxaflutole, isoxachlortole, lactofen, lenacil, linuron, maleic hydrazide, MCPA and its salts (e.g., MCPA-dimethylammonium, MCPA-potassium and MCPA-sodium, esters (e.g., MCPA-2-ethylhexyl, MCPA-butotyl) and thioesters (e.g., MCPA-thioethyl), MCPB and its salts (e.g., MCPB-sodium) and esters (e.g., MCPB-ethyl), mecoprop, mecoprop-P, mefenacet, mefluidide, mesosulfuron-methyl, mesotrione, metam-sodium, metamifop, metamitron, metazachlor, methabenzthiazuron, methylarsonic acid and its calcium, monoammonium, monosodium and disodium salts, methyldymron, metobenzuron, metobromuron, metolachlor, S-metholachlor, metosulam, metoxuron, metribuzin, metsulfuron-methyl, molinate, monolinuron, naproanilide, napropamide, naptalam, neburon, nicosulfuron, norflurazon, orbencarb, orthosulfamuron, oryzalin, oxadiargyl, oxadiazon, oxasulfuron, oxaziclomefone, oxyfluorfen, paraquat dichloride, pebulate, pelargonic acid, pendimethalin, penoxsulam, pentanochlor, pentoxazone, perfluidone, pethoxyamid, phenmedipham, picloram, picloram-potassium, picolinafen, pinoxaden, piperophos, pretilachlor, primisulfuron-methyl, prodiamine, profoxydim, prometon, prometryn, propachlor, propanil, propaquizafop, propazine, propham, propisochlor, propoxycarbazone, propyzamide, prosulfocarb, prosulfuron, pyraclonil, pyraflufen-ethyl, pyrasulfotole, pyrazogyl, pyrazolynate, pyrazoxyfen, pyrazosulfuron-ethyl, pyribenzoxim, pyributicarb, pyridate, pyriftalid, pyriminobac-methyl, pyrimisulfan, pyrithiobac, pyrithiobac-sodium, pyroxasulfone, pyroxsulam, quinclorac, quinmerac, quinoclamine, quizalofop-ethyl, quizalofop-P-ethyl, quizalofop-P-tefuryl, rimsulfuron, sethoxydim, siduron, simazine, simetryn, sulcotrione, sulfentrazone, sulfometuron-methyl, sulfosulfuron, 2,3,6-TBA, TCA, TCA-sodium, tebutam, tebuthiuron, tepraloxydim, terbacil, terbumeton, terbuthylazine, terbutryn, thenylchlor, thiazopyr, thiencarbazone, thifensulfuron-methyl, thiobencarb, tiocarbazil, topramezone, tralkoxydim, tri-allate, triasulfuron, triaziflam, tribenuron-methyl, triclopyr, triclopyr-butotyl, triclopyr-triethylammonium, tridiphane, trietazine, trifloxysulfuron, trifluralin, triflusulfuron-methyl, tritosulfuron and vernolate. Other herbicides also include bioherbicides such as Alternaria destruens Simmons, Colletotrichum gloeosporiodes (Penz.) Penz. & Sacc., Drechsiera monoceras (MTB-951), Myrothecium verrucaria (Albertini & Schweinitz) Ditmar: Fries, Phytophthora palmivora (Butl.) Butl. and Puccinia thlaspeos Schub.

Mixtures and compositions of this invention can also include herbicide safeners such as benoxacor, BCS (1 -bromo-4-[(chloromethyl)sulfonyl]benzene), cloquintocet-mexyl, cyometrinil, cyprosulfonamide, dichlormid, 2-(dichloromethyl)-2-methyl-1,3-dioxolane (MG 191), fenchlorazole-ethyl, fenclorim, flurazole, fluxofenim, furilazole, isoxadifen-ethyl, mefenpyr-diethyl, methoxyphenone ((4-methoxy-3-methylphenyl)(3-methylphenyl)-methanone), naphthalic anhydride (1,8-naphthalic anhydride) and oxabetrinil to increase safety to certain crops. Antidotally effective amounts of the herbicide safeners can be applied at the same time as diuron, hexazinone and tembotrione, or applied as seed treatments. Therefore an aspect of the present invention relates to a herbicidal mixture or composition comprising diuron, hexazinone and tembotrione and an antidotally effective amount of a herbicide safener. Seed treatment is particularly useful for selective weed control, because it physically restricts antidoting to the crop plants. Therefore a particularly useful embodiment of the present invention is a method for selectively controlling the growth of undesired vegetation in a crop comprising contacting the locus of the crop with a herbicidally effective amount of a mixture or composition of this invention wherein seed from which the crop is grown is treated with an antidotally effective amount of a safener. Antidotally effective amounts of safeners can be easily determined by one skilled in the art through simple experimentation.

Mixtures and compositions of this invention can also include plant growth regulators such as aviglycine, N-(phenylmethyl)-1H-purin-6-amine, epocholeone, gibberellic acid, gibberellin A₄ and A₇, harpin protein, mepiquat chloride, prohexadione calcium, prohydrojasmon, sodium nitrophenolate and trinexapac-methyl, and plant growth modifying organisms such as Bacillus cereus strain BP01.

Mixtures of diuron, hexazinone and tembotrione are highly active herbicides, providing unexpected utility for control of weeds because of synergy on the weeds. Mixtures of diuron, hexazinone and tembotrione are useful for both preemergent and postemergent weed control. Synergism is obtained from both preemergent and postemergent applications, but the synergistic effect is particularly significant in postemergent treatment, especially on larger weeds. The synergistic effect is also particularly significant on weeds for which diuron, hexazinone and tembotrione individually do not provide high levels of control at desired application rates and weed growth stage. Such problematic weeds include monocot species such as grasses (Family Poaceae), for example Digitaria species such as Digitaria nuda Schumacher (naked crabgrass) and Digitaria horizontalis Willd. (Jamaican crabgrass), and sedges (Family Cyperaceae), for example Cyperus species such as Cyperus esculentus L. (yellow nutsedge). The present mixtures and compositions can also be used to synergistically control weed biotypes that are resistant to triazine and other herbicides that inhibit photosystem II (PSII).

The herbicidal mixtures and compositions of the present invention can be applied to a variety of important agronomic crops, particularly in directed applications to minimize contact with the crop plants. Such important agronomic crops include, but are not limited to, alfalfa, pineapple, sugarcane and conifers (e.g., loblolly pine). Mixtures of this invention can be used in crops genetically transformed or bred to incorporate resistance to herbicides, express proteins toxic to invertebrate pests (such as Bacillus thuringiensis toxin), and/or express other useful traits. Established crops may be sufficiently tolerant to the present herbicidal mixtures and compositions to allow foliage contact without causing excessive injury. Of note is the method of the present invention wherein the locus of the undesired vegetation is a crop selected from alfalfa, pineapple, sugarcane and conifers. The herbicidal mixtures and compositions of the present invention also have utility for broad-spectrum pre- and/or postemergence weed control in areas where complete control of all vegetation is desired such as around fuel storage tanks, industrial storage areas, farm buildings, parking lots, drive-in theaters, air fields, river banks, irrigation and other waterways, around billboards and highway and railroad structures. Furthermore the herbicidal mixtures and compositions can be used to control weeds after harvest or removal of a crop and in fallow situations.

The present mixture and composition comprising diuron, hexazinone and tembotrione are especially useful for selective control of weeds in sugarcane crops. Mixtures of diuron and hexazinone have long been used for weed control in sugarcane. Although such mixtures of diuron and hexazinone provide excellent control of a broad spectrum of weed species, they are weak on the particular crabgrass species Digitaria nuda. Furthermore other herbicides commercially used for weed control in sugarcane crops are also weak on Digitaria nuda. As result of lack of effective herbicide control and release from competition of other weeds, Digitaria nuda has proliferated and become a serious pest. Yellow nutsedge (Cyperus esculentus) also is not well controlled by diuron and hexazinone, and is a serious pest in sugarcane as well as other crops. Although tembotrione alone is also weak on these weed species, the combination of diuron and hexazinone with tembotrione has now been discovered to provide control through a strong synergistic effect.

As the mixtures have both preemergent and postemergent herbicidal activity, to control undesired vegetation by killing or injuring the vegetation or reducing its growth, the compounds can be usefully applied by a variety of methods involving contacting a herbicidally effective amount of a mixture of the invention, or a composition comprising said mixture and at least one additional component selected from surfactants, solid diluents and liquid diluents, to the locus of the undesired vegetation, which can include the foliage or other part of the undesired vegetation or the environment of the undesired vegetation such as the soil or water in which the undesired vegetation is growing or which surrounds the seed or other propagule of the undesired vegetation.

As already mentioned, the mixtures can be applied to wide variety of important agronomic crops, particularly in directed applications, to selectively control undesired vegetation growing among the crop plants (i.e. desired vegetation). For control of undesired vegetation in a crop, the locus of the undesired vegetation being controlled can be described as being in the crop, or alternatively and more concisely, the locus of the undesired vegetation is the crop, wherein in this context the crop is considered to be the locus of the crop plants, which also inherently includes the locus of the undesired vegetation being controlled.

The mixture and composition according to the present invention comprises herbicidally effective amounts of diuron, hexazinone and tembotrione, and more particularly, synergistically effective amounts of diuron, hexazinone and tembotrione. Any additional biologically active compound or agent in the mixture or composition is also present in a biologically effective amount. The herbicidal composition of the present invention comprises diuron, hexazinone and tembotrione. The method of controlling undesired vegetation comprises applying a herbicidally effective amount of the mixture or composition to the locus of the undesired vegetation. The herbicidally effective amount of the mixture or composition of this invention is determined by a number of factors. These factors include: formulation selected, method of application, amount and type of vegetation present, growing conditions, etc. Herbicidally effective amounts of mixtures and compositions comprising diuron, hexazinone and tembotrione as well as biologically effective amounts of additional biologically active compounds or agents included in the mixture or composition can be easily determined by one skilled in the art through simple experimentation for the desired level of weed control. Furthermore typical agronomically useful application rates of biologically active compounds or agents are published on product labels and references such as The Pesticide Manual, Thirteenth Edition, C. D. S. Tomlin Ed., BCPC, Hampshire, UK, 2003 and The BioPesticide Manual, Second Edition, L. G. Copping, Ed., British Crop Protection Council, Farnham, Surrey, UK, 2001.

The synergism between diuron, hexazinone and tembotrione is exhibited over a wide range of weight ratios of diuron, hexazinone and tembotrione. Indeed synergism is evident with amounts of diuron, hexazinone and tembotrione which separately provide relatively little herbicidal effect. Synergistically effective amounts of diuron, hexazinone and tembotrione in the present mixture and composition can be easily determined by one skilled in the art through simple experimentation.

In the mixture and composition of the present invention, diuron and hexazinone are typically present in a weight ratio from about 20:1 to about 2:1 and more typically from about 10:1 to about 3:1. Of particular note are weight ratios of diuron to hexazinone of about 39:11, about 4:1 and about 8:1. Diuron and tembotrione are typically present in a weight ratio from about 200:1 to about 1:1. More typically the weight ratio of diuron to tembotrione is from about 100:1 to about 3:1. Most typically the weight ratio of diuron to tembotrione is from about 50:1 to about 8:1. Hexazinone and tembotrione are typically present in a weight ratio from about 40:1 to about 1:4. More typically the weight ratio of hexazinone to tembotrione is from about 20:1 to about 1:2. Most typically the weight ratio of hexazinone to tembotrione is from about 10:1 to about 1:1. The total weight of diuron, hexazinone and tembotrione in the mixture and composition of the present invention applied to the locus of the undesired vegetation is typically not less than about 0.5 kg/ha or greater than about 12 kg/ha. More typically the total weight of diuron, hexazinone and tembotrione applied is between about 0.9 kg/ha and about 6 kg/ha. Most typically the total weight of diuron, hexazinone and tembotrione applied is between about 1 kg/ha and about 4 kg/ha.

The following Test demonstrates the control efficacy of the mixtures of this invention against a specific weed. The weed control afforded by the mixtures is not limited, however, to this species.

### Biological Examples of the Invention

### Test A

Plastic pots (10-cm square) were filled to the rim with a sandy loam soil having pH of 6.1, 1.4% organic matter and a cation exchange capacity (CEC) of 5.7 milliequivalents per 100 grams (meq/100 g). The soil was tamped firm to a uniform level of 2.5 cm below the rim of each pot. A measured amount of seeds of Digitaria nuda were scattered on the soil surface. Seeded pots were covered with approximately 50 mL of the same planting soil and tamped. The pots were then placed in a greenhouse and watered thoroughly 2-3 times daily as needed. A balanced fertilizer solution was injected into the watering system to provide 218 ppm of nitrogen. Artificial lighting was used to supplement natural light to produce a 14 h photoperiod. Greenhouse temperatures were targeted for 28.8 ° C. in the day and 19.8 ° C. at night.

When the D. nuda plants reached the 3-4-leaf growth stage (8-12 cm height), the pots were sorted into test units for herbicide application. Treatments were replicated three times. The herbicides were diluted in a measured amount of water and then mixed using a magnetic stir bar for 10 minutes before aliquots were taken to make individual treatment solutions. Diuron was in the form of the DuPont product KARMEX, which is a wettable granule formulation containing 80 weight % active ingredient. Hexazinone was in the form of the DuPont product VELPAR DF, which is a wettable granule formulation containing 75 weight % active ingredient. A mixture of hexazinone and diuron in 11:39 weight ratio was in the form of the DuPont product VELPAR-K (VELPAR-K4) 60 WG, which is a wettable granule formulation containing 13.2 weight % hexazinone and 46.8 weight % diuron active ingredients. A mixture of hexazinone and diuron in 1:8 weight ratio was in the form of the DuPont product VELPAR-K8 (marketed in Brazil as ADVANCE Herbicide), which is a wettable granule formulation containing 6.7 weight % hexazinone and 53.3 weight % diuron active ingredients. Tembotrione was in the form of the Bayer product LAUDIS, which was a suspension concentrate formulation stated to contain 44 g tembotrione active ingredient and 22 g isoxadifen-ethyl (a herbicide safener) per liter. These products were applied alone and in combinations. Application rates of diuron and hexazinone were 1800 and 210 g ai ha⁻¹, respectively. The application rates of the VELPAR-K4 mixture of hexazinone and diuron (132 g a.i. hexazinone+468 g a.i. diuron/kg of formulated product) and VELPAR-K8 mixture of hexazinone and diuron (67 g a.i. hexazinone+533 g a.i. diuron/kg of formulated product) were 1200 and 1800 g total a.i. ha⁻¹, respectively. Application rates of tembotrione were 30, 60, 90 and 120 g a.i./ha. (“a.i.” means active ingredient.) The pots were then sprayed through a T-Jet 8002E nozzle using a stationary belt sprayer calibrated to deliver 281 L/ha at 276 kPa. Treatments were replicated three times.

The plants were returned to the greenhouse, and then control was visually evaluated relative to the control plants at 7 days after treatment (DAT). A numerical percent rating system was used to describe the response observed from each treatment on a scale of 0 to 100%, in which 0% indicates no response and 100% indicates plant death or near death. The reported results are the mean averages of the three replicates.

Colby's Equation was used to determine the herbicidal effects expected from the mixtures. Colby's Equation (Colby, S. R. “Calculating Synergistic and Antagonistic Responses of Herbicide Combinations,” Weeds, 15(1), pp 20-22 (1967)) calculates the expected additive effect of herbicidal mixtures, and for two active ingredients, or a pair of active ingredients (e.g., diuron+hexazinone) combined with an additional active ingredient (e.g., tembotrione), is of the form:

P_{a+b}=Pₐ+P_{b}−(PₐP_{b}/100)

wherein P_{a+b} is the percentage effect of the mixture expected from additive contribution of the individual components,
Pₐ is the observed percentage effect of the first active ingredient or pair of active ingredients at the same use rate as in the mixture, and
P_{b} is the observed percentage effect of an additional active ingredient at the same use rate as in the mixture.

The observed and expected results are listed in Table A.

TABLE A*
Effect of herbicides, alone and in combination, on Digitaria nuda

| Application Rate | | | | |
|---|---|---|---|---|
| (g a.i./ha) | | | % Control | |
| Diuron | Hexazinone | Tembotrione | Observed | Expected |
| — | — | 30 | 37 | — |
| — | — | 60 | 40 | — |
| — | — | 90 | 53 | — |
| — | — | 120 | 60 | — |
| 1800 | — | — | 20 | — |
| 1800 | — | 30 | 70 | 49 |
| 1800 | — | 60 | 82 | 52 |
| 1800 | — | 90 | 99 | 63 |
| 1800 | — | 120 | 96 | 68 |
| — | 210 | — | 12 | — |
| — | 210 | 30 | 37 | 44 |
| — | 210 | 60 | 60 | 47 |
| — | 210 | 90 | 53 | 58 |
| — | 210 | 120 | 65 | 65 |
| 936 | 264 | — | 23 | — |
| 936 | 264 | 30 | 73 | 51 |
| 936 | 264 | 60 | 94 | 54 |
| 936 | 264 | 90 | 99 | 64 |
| 936 | 264 | 120 | 100 | 69 |
| 1600 | 200 | — | 30 | — |
| 1600 | 200 | 30 | 85 | 56 |
| 1600 | 200 | 60 | 87 | 58 |
| 1600 | 200 | 90 | 88 | 67 |
| 1600 | 200 | 120 | 98 | 72 |

*Application rates are expressed as grams of active ingredient per hectare (g a.i./ha) for diuron, hexazinone and tembotrione. Observed herbicidal effect is reported as percent control based on mean responses from three replicates. Expected herbicidal effect is calculated according to the Colby equation.

This test showed that while mixing tembotrione with diuron provided considerable synergistic effect, mixing tembotrione with hexazinone generally did not result in synergism. This demonstrates that synergy involving even herbicides having the same mode of action is not predictably consistent. The mixtures of tembotrione with diuron and hexazinone according to the present invention showed strong synergy. In these mixtures including diuron, hexazinone did not appear to diminish the synergy and indeed helped provide an even stronger effect. The lowest total active ingredient use rate achieving greater that 90% control was obtained from 936 g/ha of diuron, 264 g/ha of hexazinone and 60 g/ha of tembotrione.

1. A mixture comprising diuron, hexazinone and at least one compound selected from tembotrione and salts thereof.

2. The mixture of claim 1 further comprising at least one additional biologically active compound or agent.

3. The mixture of claim 1 not further comprising an additional herbicidally active compound or agent.

4. A herbicidal composition comprising the mixture of claim 1, and at least one additional component selected from the group consisting of surfactants, solid diluents and liquid diluents.

5. A herbicidal composition comprising the mixture of claim 2, and at least one additional component selected from the group consisting of surfactants, solid diluents and liquid diluents.

6. A herbicidal composition comprising the mixture of claim 3, and at least one additional component selected from the group consisting of surfactants, solid diluents and liquid diluents.

7. The herbicidal composition of claim 4 which is a homogeneous mixture comprising two groups of substantially cylindrical granules, the groups having different herbicide contents, the first group of granules comprising diuron and hexazinone and at least one solid diluent, and the second group of granules comprising at least one compound selected from tembotrione and salts thereof and at least one solid diluent, the granules within each group having substantially uniform diameters and longitudinal lengths of from 1 to 8 times the diameter with the average length of the granules being from 1.5 to 4 times the diameter, and the average diameter of the second group differing from the first group by no more than 30%.

8. The herbicidal composition of claim 4 which is a homogeneous mixture comprising three groups of substantially cylindrical granules, the groups having different herbicide contents, the first group of granules comprising diuron and at least one solid diluent, the second group of granules comprising hexazinone at least one solid diluent and the third group of granules comprising at least one compound selected from tembotrione and salts thereof and at least one solid diluent, the granules within each group having substantially uniform diameters and longitudinal lengths of from 1 to 8 times the diameter with the average length of the granules being from 1.5 to 4 times the diameter, and the average diameter of the second group differing from the first group by no more than 30%.

9. A method of controlling undesired vegetation comprising applying to the locus of the undesired vegetation a herbicidally effective amount of the mixture of claim 1.

10. The method of claim 9 wherein the locus of the undesired vegetation is in an alfalfa, conifer, pineapple or sugarcane crop.

11. The method of claim 10 wherein the locus of the undesired vegetation is in a sugarcane crop.

12. The method of claim 9 wherein the locus of the undesired vegetation is other than in a crop.

13. A method of controlling undesired vegetation comprising applying to the locus of the undesired vegetation a herbicidally effective amount of the mixture of claim 2.

14. A method of controlling undesired vegetation comprising applying to the locus of the undesired vegetation a herbicidally effective amount of the mixture of claim 3.
